(19) United States
(12) Patent Application Publication
(10) Pub. No.: US 2004/0222557 A1
(43) Pub. Date: Nov. 11, 2004

(54) Insert molding tool for spray polyurethane

(75) Inventor: Kenneth R. Parrish, Roseville, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/430,571

(22) Filed: May 6, 2003

(51) Int. Cl. B29C 51/10; B29C 41/08; B29C 41/20; B29C 51/14; B29C 41/50

(52) U.S. Cl. 264/275; 264/553; 264/511; 264/279; 264/334; 425/388

(57) ABSTRACT

A method of forming an interior trim part having an insert and a spray formed layer. The insert has a rib that is received in a groove formed in a surface of the mold. The groove is provided with a vacuum port that may be used to draw the insert into the groove while the spray polymer layer is applied over at least a portion of the back of the insert. The bead receiving groove may be partially formed by a tool insert to which the vacuum is ported. The insert may be formed as a multi-layer film including a backing layer, decoration layer and clear coat layer. The multi-layer film may be vacuum formed to create a bead or rib on the insert. The method and tool may be used to form an interior trim part such as a floor covering with integral floor mats.

### BACKGROUND OF THE INVENTION

1. Field of the Invention

The present invention relates to insert molding for molding vehicle interior trim parts that include an insert or design feature to which the polyurethane material is molded.

2. Background Art

Vehicle interiors are manufactured in many parts that are made to exacting quality standards that assure an aesthetically appealing and a durable vehicle interior.

Vehicle interior components may be made up of a wide variety of materials including polyurethane, polyvinylchloride, leather, carpet, and precision molded plastic parts. Fit and finish requirements must be met consistently and moldings must be precisely controlled with sharply formed edges.

Inserts may be used to provide decorative surfaces, wear resistant areas and product insignia displays. Insert molding interior parts presents a manufacturing challenge due to the dynamic forces of molten materials flowing within a molding die. Also, close tolerances must be maintained between inserts and the molded parts to which they are applied or unacceptable rejection and scrap rates will be encountered. Any irregular seams or joining lines around inserts that are molded into insert molded parts may render a part unacceptable. Perfectly molded edges are difficult to achieve in prior art insert molding processes.

The present invention is directed to solving the above problems and other problems as summarized below.

### SUMMARY OF THE INVENTION

According to one aspect of the invention, a method of making an interior trim part is provided. The method comprises heating an insert blank and loading the insert blank into a vacuum forming tool having a groove. An edge bead is formed on the insert blank by drawing a portion of the insert blank into the groove to create a formed insert. The formed insert is removed from the vacuum forming tool and loaded into a spray forming die having a forming surface with the edge bead being placed into an insert edge receptacle groove. The edge groove is suctioned into the insert edge receptacle groove. A polymer composition is sprayed onto the spray forming die to coat the spray forming surface thereby forming a layer comprising part of the trim part and also coating at least part of the formed insert to join the formed insert to the layer. The polymer composition is allowed to cure and solidify thereby forming the trim part. The trim part is then removed from the spray forming die and, if necessary, may be trimmed to remove any over spray or flashing.

According to other aspects of the method of the invention, the receptacle groove may have a tool insert lining the receptacle groove that is formed of cast polyurethane. The receptacle groove may also have a lip formed of the same material as the spray forming die at the intersection of the formed insert and the layer formed by the spray polymer composition. A vacuum port may be provided through the tool insert and the spray forming tool in the edge receptacle groove through which vacuum is ported to perform the suctioning step.

According to another aspect of the method of forming an interior trim part, the edge bead may be formed on the formed insert with a protruding rib on a facing side and a corresponding groove being formed on the back side of the insert. The spray polymer composition may be deposited in the groove on the back side of the formed insert to facilitate securing the insert to the layer formed by the polymer composition.

In accordance with the method, the polymer composition may be polyurethane. The insert may be a multiple layer film article. The multiple layer film article may comprise a backing layer, a decorative layer, and a clear coat layer. The decorative layer may be a painted or pigmented film or may also be a silkscreen, photo print, lithograph or other decorative layer that could be used to create a textured appearance or logo. The decorative layer is covered by a clear coat layer or clear film layer. The backing layer provides a durable reinforcement that protects the back side of the decorative layer.

According to another aspect of the method, the interior trim part may comprise a non-carpeted floor covering for a vehicle while the insert comprises an integral floor mat.

According to another aspect of the invention, a tool is provided for spray forming an interior trim part for a vehicle. The interior trim part has an insert that is attached to the trim part when it is spray formed. The insert has a face surface and a back surface with a pre-formed bead extending around at least a portion of the insert near the periphery of the insert. The tool comprises a mold defining a mold surface. The mold surface has a bead receptacle groove in which the bead of the insert is received when the insert is placed on the mold surface with the face side of the insert facing the mold surface. A spray apparatus is provided for spraying a polymer composition on the mold surface and on the back surface of the insert. A vacuum source ported to the receptacle groove draws the bead into the receptacle groove while a polymer spray gun sprays the polymer composition on the mold surface and on the back surface of the insert. The vacuum source may also be ported to other portions of the insert that are within the periphery of the grooves.

According to another aspect of the invention as it relates to the tool forming an interior trim part, a tool insert may be provided in the mold that forms a lining for the receptacle groove. The tool insert is formed from a different and softer material than the mold such as cast, or solid, polyurethane. The mold and tool insert have vacuum ports through which the vacuum source is provided through a receptacle groove. An outboard edge of the receptacle groove is preferably formed by the mold with the remaining portions of the receptacle groove being formed by the tool insert. The tool may be used to form a molded vehicle floor covering having a plurality of inserts that form integral floor mats in the finished product.

These and other aspects of the invention as it relates to both the method and the tool for making an interior trim part will be better understood in view of the attached drawings and following detailed description of the best mode for carrying out the invention.

### BRIEF DESCRIPTION OF THE DRAWINGS

FIG. 1 is a perspective view of a tool for forming an interior trim part such as a non-carpeted floor covering in accordance with the present invention;

FIG. 2 is a cross-sectional view of a vacuum forming tool for forming an insert comprising part of the interior trim part made according to the present invention;

FIG. 3 is a fragmentary perspective view shown partially in cross section taken along the line 3-3 in FIG. 1;

FIG. 4 is a cross-sectional view taken along the line 4-4 in FIG. 1; and

FIG. 5 is a cross-sectional view of an alternative embodiment of the invention taken along a line similar to the cross-sectional view of FIG. 4.

### DETAILED DESCRIPTION OF THE PREFERRED EMBODIMENT(S)

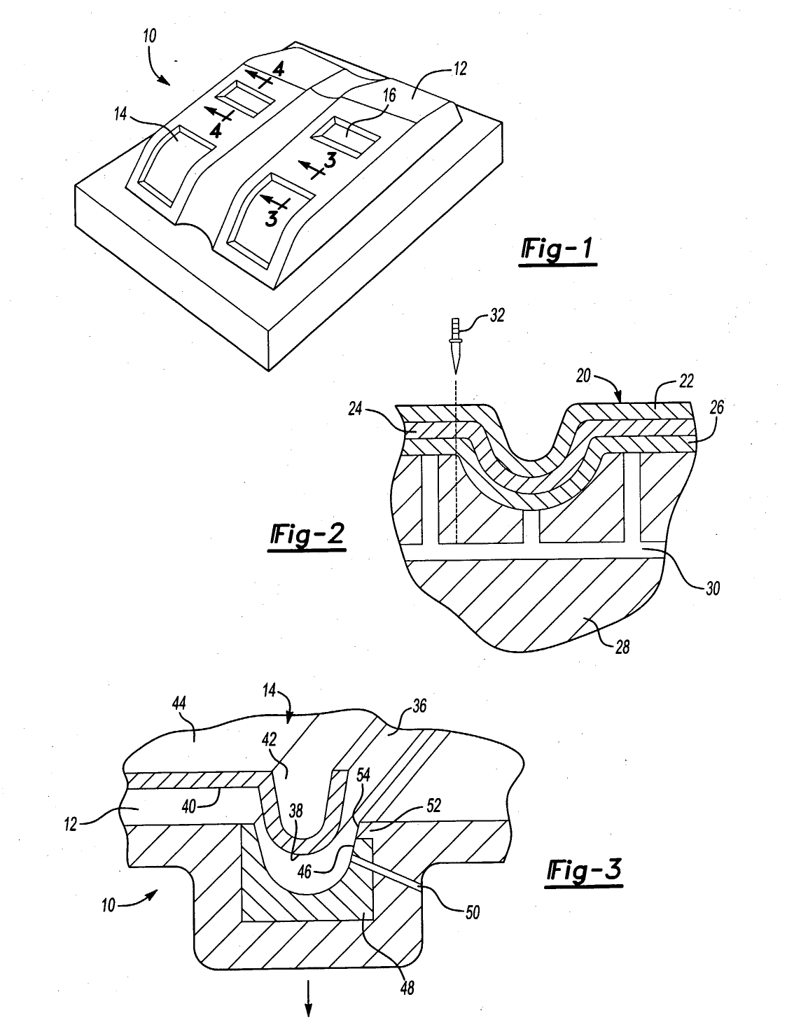

Referring to FIG. 1, a spray forming mold 10 is illustrated that has a mold surface 12 for forming an interior trim part such as a non-carpeted floor covering. The mold surface 12 includes front inserts 14 for integrally formed front floor mats and rear inserts 16 for integrally formed rear floor mats.

Inserts 14 and 16 may be formed from a multi-layer film 20. One example of such a multi-layer film 20 is described with reference to FIG. 2. The multi-layer film 20 includes a backing layer 22 over which a decoration layer 24 is applied. The backing layer may be formed from a durable polymer film. The decoration layer 24 may be a pigmented film, lithograph, photo print or metallic foil. The decoration layer 24 is covered by a clear coat layer 26 or clear film layer that protects the decoration layer 24 and may, provide a gloss appearance for the inserts 14 and 16.

Referring to FIG. 2, the multi-layer film 20 may be formed in a vacuum forming tool 28. The multi-layer film 20 is heated to soften the film and permit the vacuum forming tool 28 to form the film 20 into a desired shape and also impart a pattern or texture, if desired. A vacuum port manifold 30 is connected to a source of vacuum (not shown) so that a vacuum pressure may be provided to draw the film 20 onto the surface of the vacuum forming tool 28. After the film 20 has been formed, a knife 32, such as a water jet knife, may be used to cut off any extra material. After the insert 14, 16 is formed and trimmed, it is transformed into a formed insert 36.

Referring to FIG. 3, formed insert 36 is loaded into the spray forming mold 10 and placed on the mold surface 12 with a bead 38, or rib, on a facing side 40 and a corresponding groove 42 on a back side 44 thereof. The bead 38 is placed on the mold surface 12 with the bead 38 being received in a bead receptacle groove 46. The bead receptacle groove 46 locates the inserts 14 and 16 in the desired location in the interior trim part. A tool insert 48 defines a portion of the bead receptacle groove 46. The tool insert 48 may be formed from cast polyurethane or solid polyurethane to provide a resilient portion of the mold surface 12. A plurality of vacuum ports 50 extend through the mold 10 and tool insert 48 to the bead receptacle groove 46. Other vacuum ports may be provided within the periphery of the grooves 46.

A lip 52 may be provided on the mold surface 12 in the bead receptacle groove 46 that provides a rigid area at the outboard edge 54 of the bead receptacle groove 46. Vacuum ports 50 are connected to a source of vacuum and are used to draw the bead 38, or rib, into the bead receptacle groove 46. The vacuum pulls the bead 38 into the groove 46 and draws it tightly against the surface of the groove 46.

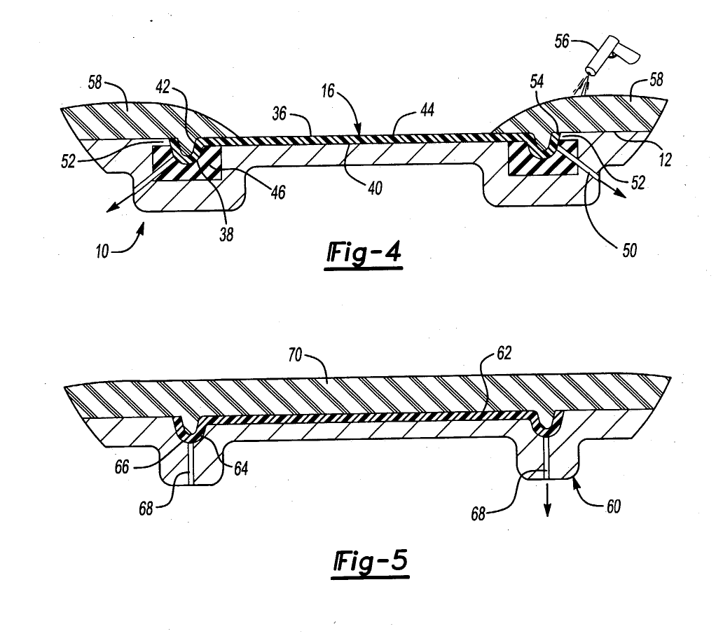

Referring to FIG. 4, the next step in the process is shown wherein a spray apparatus 56 is used to form a polymer layer 58 on the mold surface 12. The polymer layer may be a spray polyurethane material. The polyurethane material may be either an aliphatic polyurethane or aromatic polyurethane. The polymer layer 58 is sprayed on the mold surface 12 and around the perimeter of the insert 16 so that it may flow into the groove 42 formed on the back side 44 of the insert 16. The polymer layer 58 is sprayed while vacuum is drawn through the vacuum ports 50. Bead 38 is drawn by the vacuum into tight engagement with the lip 50 so that a seal is formed that prevents the polymer layer 58 from bleeding over the bead 38. In the embodiment shown in FIG. 4, the back side 44 of the insert 16 is not completely coated with the polyurethane layer 58 but the peripheral portions thereof are bonded to the polymer layer 58 with the portion of the polymer layer 58 flowing into the groove 42 on the back side 44 of the insert 16 serving to enhance the bonding properties of the polymer layer 58 by providing a mechanical interlock that further assures retention of the formed insert 36 by the polymer layer 50.

Referring to FIG. 5, an alternative embodiment is shown wherein an alternative embodiment of a spray forming mold 60 is shown. A formed insert 62 is placed in the spray forming mold 60 with a bead 64, or rib, being placed in a bead receptacle groove 66. Vacuum ports 68 are provided within the bead receptacle groove 66 to draw the insert 62 into tight engagement with the walls of the bead receptacle groove 66 to locate the insert and form a seal. While the bead 64 is drawn into the bead receptacle groove 66, a polymer layer 70 is sprayed over the entire insert 62. This approach may be preferred if it is necessary to control noise and vibration or provide additional reinforcement or support across the back of the insert 62.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an interior trim part, comprising:
heating an insert blank;
loading the insert blank into a forming tool having a groove;
forming an edge bead on the insert blank by drawing a portion of the insert blank into the groove to form a formed insert;
removing the formed insert from the forming tool;
loading the formed insert into a spray forming die having a forming surface with the edge bead being placed into an insert edge receptacle groove;
suctioning the edge groove into the insert edge receptacle groove;
spraying a polymer composition into the spray forming die to coat the spray forming surface forming a layer comprising part of the trim part and coating at least part of the formed insert to join the formed insert to the layer;
allowing the polymer composition to solidify thereby forming the trim part; and
removing the trim part from the spray forming die.

2. The method of forming an interior trim part of claim 1 wherein the receptacle groove has a tool insert lining the receptacle groove, the tool insert being formed of cast polyurethane.

3. The method of forming an interior trim part of claim 2 wherein the receptacle groove has a lip formed of the same material as the spray forming die at the intersection of the insert and the layer formed by the polymer composition.

4. The method of forming an interior trim part of claim 2 wherein a vacuum port is provided through the tool insert and the spray forming tool in the edge receptacle groove through which vacuum is ported to perform the suctioning step.

5. The method of forming an interior trim part of claim 1 wherein the edge bead is formed on the formed insert with a protruding rib on a facing side and a groove on a back side, and wherein the spray polymer composition is deposited in the groove on the back side of the formed insert to facilitate securing the insert to the layer formed by the polymer composition.

6. The method of forming an interior trim part of claim 1 wherein the polymer composition is polyurethane.

7. The method of forming an interior trim part of claim 1 wherein the insert is a multiple layer film article.

8. The method of forming an interior trim part of claim 7 wherein the multiple layer film comprises a backing layer, a decorative layer and a clear coat layer.

9. The method of forming an interior trim part of claim 1 wherein the interior trim part is a floor covering for a vehicle and the insert comprises an integral floor mat.

10. A tool for spray forming an interior trim part for a vehicle, the interior trim part having an insert that is attached to the trim part when it is spray formed, the insert having a face surface and a back surface and having a pre-formed bead extending around at least a portion of the insert near the periphery of the insert, the tool comprising:
a mold defining a mold surface, the mold surface having a bead receptacle groove in which the bead of the insert is received when the insert is placed on the mold surface with the face side of the insert facing the mold surface;
a polymer spray apparatus for spraying a polymer composition on the mold surface and on the back surface of the insert; and
a vacuum source in fluid flow communication with the receptacle groove for drawing the bead into the receptacle groove while the polymer spray gun sprays the polymer composition on the mold surface and on the back surface of the insert.

11. The tool of claim 10 further comprising a tool insert that is provided in the mold that forms a lining of the receptacle groove, the tool insert being formed from a different and softer material than the mold.

12. The tool of claim 11 wherein the mold and tool insert have vacuum ports through which the vacuum source is provided to the receptacle groove.

13. The tool of claim 11 wherein the tool insert is solid polyurethane.

14. The tool of claim 11 wherein an outboard edge of the receptacle groove is formed by the mold and the remaining portions of the receptacle groove are formed by the tool insert.

15. The tool of claim 10 wherein the tool is for forming a molded vehicle floor covering and a plurality of inserts are provided that comprise integral floor mats.
